(19) United States
(12) Patent Application Publication
(10) Pub. No.: US 2017/0132390 A1
(43) Pub. Date: May 11, 2017

(54) SYSTEM FOR IDENTIFYING CONTENTS OF MEDICATION CONTAINERS AND PROPER DOSAGE

(71) Applicant: Kenneth Moskowitz, Coconut Creek, FL (US)

(72) Inventor: Kenneth Moskowitz, Coconut Creek, FL (US)

(21) Appl. No.: 15/281,836

(22) Filed: Sep. 30, 2016

Related U.S. Application Data
(60) Provisional application No. 62/234,911, filed on Sep. 30, 2015.

(51) Int. Cl. G06F 19/00

(52) U.S. Cl. CPC G06F 19/3456

(57) ABSTRACT

A system for assisting in the proper administration of daily medications clearly identifies the patient, the times for administering the medication and the number of pills to be taken each time. In particular, the system uses labels with a coding system, including color codes, letters and numbers. The color identifies the person who is taking the medication, letter codes are used to indicate when the medication is to be taken and the numbers are used to indicate the amount of medication to be taken at each time of administration. The coded labels can be applied to the top, side and bottom of each medication container.

This non-provisional patent application is based on provisional patent application Ser. No. 62/234,911 filed Sep. 30, 2015.

### BACKGROUND OF THE INVENTION

### Field of the Invention

The present invention is directed to a system for assisting in the daily administration of multiple medications and, particularly, a system for identifying a particular medication in a container, when to take the medication, and how many (i.e., pills, capsules, tablets, etc.) to take at each time of administration.

### Discussion of the Related Art

Orally administered medications (i.e., in pill, capsule or tablet form) are typically packaged in small bottles or containers that have labels displaying the medication name and directions for proper dosage. For instance, prescription medications are often filled in similar containers with labels that have small print that is difficult to read. In particular, when filling a prescription, pharmacies use small bottles with labels on the side that identify the medication, the patient name and the dosage instructions. The size of the print on the label is relatively small and many people, particularly the elderly, find it extremely difficult to read the prescription medication label. Moreover, a vast variety of prescription medications are filled in very similar, and are often packaged in identical bottles. This can lead to confusion and dosage errors, particularly for patients that are required to take a number of different medications on a daily basis. For instance, some people may be required to take a number of different medications several times each day, while taking other medications only once per day or on a less frequent basis. Moreover, they may need to take several pills of a particular medication for each dosage, while only needing to take one pill for other medications. People taking a variety of medications on a daily basis will often ask themselves, “Did I take all of my pills?” Or, “Which ones did I already take?” The confusion caused by the similarity in the bottles and labels that are difficult to read leads to fear of either missing required dosages or taking an extra dose or overdose.

It is estimated that over 500,000 dosage errors are made each year in the U.S. alone. Most of the errors are a result of patient confusion situations where patients are required to take multiple medications on a daily basis.

The present invention provides a system to significantly reduce errors in taking daily medications, even in situations where there are multiple people in the same household taking daily medications. The system of the present invention uses a coding system that allows members of a household to instantly identify which medicine belongs to each person, how much of each medication is required to be taken at each administration (dosage), when to take the medication and how often to take the medication.

### BRIEF DESCRIPTION OF THE DRAWINGS

For a fuller understanding of the nature of the present invention, reference should be made to the following detailed description taken in conjunction with the accompanying drawings in which:

FIG. 1 is a perspective view showing several containers of different medications for the same person, and wherein the identifying system of the present invention has been applied to the multiple containers;

FIG. 2 is a top plan view showing a label applied to a top of the container and in accordance with the system of the present invention; and

FIG. 3 is a bottom plan view showing a label applied to the bottom of a medication container in accordance with the identifying system of the present invention.

Like reference numerals refer to like parts throughout the several views of the drawings.

### DETAILED DESCRIPTION OF THE PREFERRED EMBODIMENT

The present invention is directed to a system for identifying the content of medication containers, as well as for identifying who the medication belongs to, when the medication is to be taken, and how many pills, capsules, tablets, etc. are to be taken at each administration.

In accordance with the present invention, identifying labels are applied to each of the plurality of medication containers 12 belonging to any particular person. More specifically, a first label 20 is applied to the tops 14 of each of the containers 12. A second label 22 may be applied to the sides 16 of each of the containers 12. Finally, as seen in FIG. 3, a third label 24 is applied to the bottom 18 of each container 12.

The system of the present invention is specifically designed to instantly identify the person to whom all of the medication bottles belong to. More specifically, the labels 20, 22 and 24 are color coded to identify the person who is taking the medication in that bottle. The labels 20, 22 and 24 are all of the same color for any one individual, so that that particular color corresponds to the particular individual that is taking that medication. For example, in a household where both a husband and wife are each taking multiple medications, the labels 20, 22 and 24 on the husband's medication containers may be color coded blue, while the labels 20, 22 and 24 on the wife's medication containers may be all color coded pink.

The system of the present invention is further adapted to quickly identify when a person is to take a particular medication. This can be achieved with the use of letters that provide an abbreviation for the time of day and/or an event related to the time of taking the medication. Examples of letter codes used to indicate when to take a medication are as follows:

BB—meaning “Before Breakfast”

WB—meaning “With Breakfast”

AB—meaning “After Breakfast”

BL—meaning “Before Lunch”

WL—meaning “With Lunch”

AL—meaning “After Lunch”

BD—meaning “Before Dinner”

WD—meaning “With Dinner”

AD—meaning “After Dinner”

PB—meaning “Prior to Bed”

AW—meaning upon “Awakening” in the morning

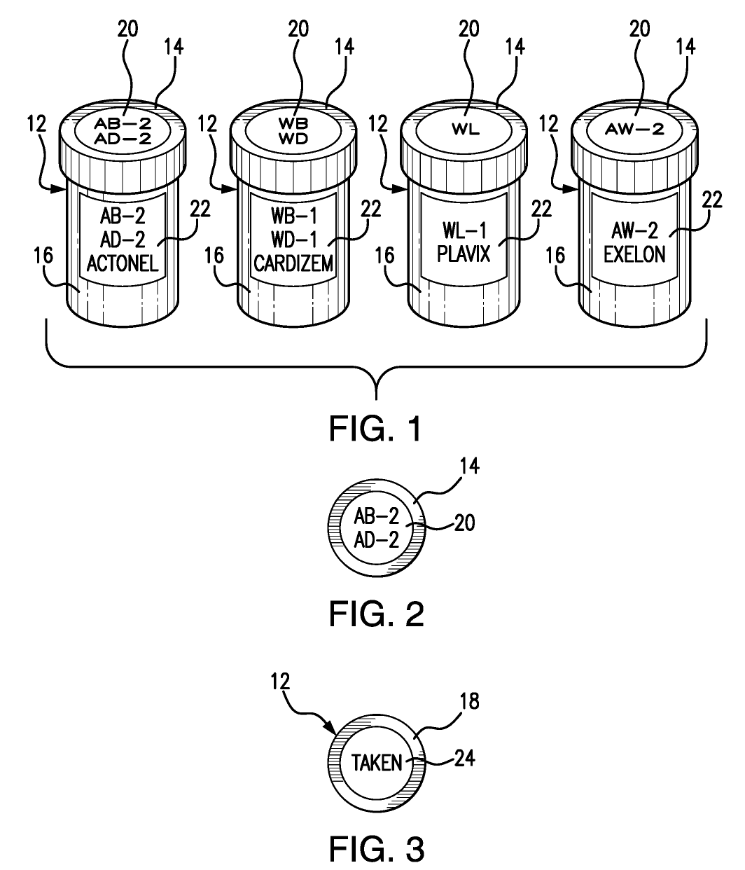

The number of pills, capsules, tablets, etc. to be taken for each medication, at each time of administration, is simply indicated by a number or digit. For instance, if two pills are required to be taken after breakfast and then again after dinner, the label 20 on the top of the container as well as the label 22 on the side of the container would have the codes “AB-2” and “AD-2” as seen in FIGS. 1 and 2. If only one pill (or capsule, tablet, etc.) is to be taken at each of the indicated times, then either the number “1” or no number is displayed on the label.

After each medication is taken at the indicated time, the person taking the medication replaces the cap on the container and turns the container upside down so that the bottom label 24 faces up. The bottom label indicates that the medication has been taken. The bottom label can be provided with an indicator such as “TAKEN” or “DONE.” After all required medications have been taken at a particular medication administration time, all of the bottles can be returned to their upright position and replaced into a tub, tray or other holding device to keep each person's medication containers all together and easy to access for the next administration time.

While the present invention has been shown and described in accordance with a preferred and practical embodiment thereof, it is recognized that departures from the instant disclosure are fully contemplated within the spirit and scope of the present invention.

What is claimed is:

1. A method for assisting a person with the proper administration of daily medications comprising:
providing the person with a plurality of different daily medications;
providing a plurality of containers, each container containing one of the plurality of medications;
color coding each of the plurality of containers for identifying the person who is taking the medication in each of the plurality of containers;
applying alpha-numeric codes to each of the plurality of containers to indicate when each medication in each of the plurality of containers is to be taken and the proper dosage to be taken at each time; and
providing an indicator on each of the plurality of containers for indicating that the medication in the container has already been taken for that particular day.

2. The method as recited in claim 1 wherein the alpha-numeric codes include letter codes for indicating when, during the course of the day, the medication in the respective container is to be taken.

3. The method as recited in claim 2 wherein the alpha-numeric codes include number codes for indicating the proper dosage to be taken at each time of administration of the medication in each of the plurality of containers.

4. The method as recited in claim 3 wherein the alpha-numeric codes are applied to a top of each of the plurality of containers.

5. The method as recited in claim 4 wherein the alpha-numeric codes are applied to a side of each of the plurality of containers.
